(19) United States
(12) Patent Application Publication
(10) Pub. No.: US 2015/0056579 A1
(43) Pub. Date: Feb. 26, 2015

(54) PORTION CONTROL DEVICE

(71) Applicant: CYNTHIA DIANE WULF, BRISTOW, VA (US)

(72) Inventor: CYNTHIA DIANE WULF, BRISTOW, VA (US)

(21) Appl. No.: 13/974,003

(22) Filed: Aug. 22, 2013

(51) Int. Cl. G09B 19/00; G01G 19/41

(52) U.S. Cl. CPC G09B 19/0092; G01G 19/41; B65D 90/48
USPC 434/127

(57) ABSTRACT

An adjustable portion control device is disclosed. The portion control device can be comprised of a portion container with a circular interior, a circular rotating platform, and a measurement indicator located upon the portion container. The rotating platform is lowered within the portion control container to an adjustable target weight indicated by the measurement indicator for providing an appropriate amount of food for that target weight.

### TECHNICAL FIELD OF THE INVENTION

The present invention relates to the general art of wellness and health, and to the particular field of portion control.

### BACKGROUND OF THE INVENTION

Overeating is a continuous and large-scale problem in this country. According to the US Center for Disease Control and Prevention, more than one-third of Americans are now obese. The consequences of overeating and excess weight can be severe, and it can lead to health issues like high blood pressure, diabetes, and decreased energy. A key reason for this overeating is the common serving of inappropriate, too-large portion sizes.

In fact, critical in both lose weight and maintaining a healthy weight is proper portion control, which is limiting the portions of foods consumed throughout the day to what is necessary. Understanding correct portion sizes is not just important to weight loss and longer term weight management, it is absolutely necessary. However, research has shown that Americans tend to think they eat less than they do, often underestimating portion sized by 20% or more, leading to the common consumption of too-large portion sizes. Perceptions of what a correctly portioned meal looks like is further skewed by dining out. The portion sizes served by many restaurants are typically far larger than is advisable for a single meal.

Most Americans are aware both that they eat too much and that they need to lose weight. Every year, millions attempt to eat properly and lose weight, and a multi-billion dollar dieting industry has surfaced to assist these efforts.

There are several ways that portion control is typically addressed. Portion control is sometimes addressed by hiring a nutritionist to explain how much to eat. Others hire weight loss companies that have in-person meetings and other exhaustive and expensive ways of addressing portion control, including detailed plans and point systems. Also, there are plates with fixed portion spaces. However, these plates have a one-size fits all model in which all size users eat the same allocated portions, no matter the users ideal weight. This can lead, depending on the user, to overeating or under-eating. Further, there are companies that sell pre-portioned meals, which can be ordered. However, this service tends to be expensive, and unless the user plans to continue the service for life, is not a long-term solution to portion control.

Despite all these methods, systems and the awareness of Americans that they need to lose weight, the weight problems of Americans are becoming worse, not better, and the results for Americans who attempt to lose weight are decidedly mixed.

Therefore, there is a need for a simple and affordable method to monitor and adjust portions of food consumed at each meal to achieve weight loss and management goals.

### SUMMARY

These and other objects are achieved by a portion control device featuring a portion container with a circular interior, a circular rotating platform that can be adjusted to a depth within the portion control container indicated by a measurement indicator on the side of the portion container. The measurement indicator shows a number of weights or weight ranges, in pounds or kilograms, across a range of the roost likely target or maintenance weights for people to want to reach. Typically, the range of weight or weights are between about 100 pounds and about 210 pounds.

The portion container is comprised of a circular bottom, a circular container wall attached to the circular bottom at the bottom of the container wall, and a handle extending from the container wall. The portion container further has a set of male threads on the inside of the container wall that spiral downward into the container.

In a preferred embodiment, the portion container and the rotating platform are both a single piece construction of a translucent food grade plastic. The rotating platform has a circular top with finger indentations to help make rotating the platform faster and easier, and a circular side wall high enough to accommodate a set of female threads.

In further embodiments, the portion container and rotating platform can either or both be comprised of non-translucent plastic, a plurality of plastics, glass, metal, silicone, rubber, or wood, or any combination of these.

In additional embodiments, the rotating platform is either a single solid piece or a hollow single piece construction.

In other embodiments, the thread types can be reversed, so that the rotating platform would have a set of male threads and the portion container would have a set of at least two female threads.

In yet another embodiments, the platform can include a divider that can separate the interior of the portion container into distinct sections so that different kinds of food can be separated when added.

Additionally, the rotating platform cars be adjusted within the portion container by means other than a set of threads, such as a series of adjustable tongues and grooves or as an adjustable plunger type system. If an adjustment system other than threads is used, the rotating platform and portion container need not be circular, bat can be any suitable shape, such as rounded or rectangular.

### BRIEF DESCRIPTION OF THE DRAWINGS

FIG. 1 is a frontal perspective view of an embodiment of the present invention.

FIG. 2 is another frontal perspective view of the embodiment shown in FIG. 1.

FIG. 3 is a top plan view of the embodiment shown in FIG. 1.

FIG. 4 is frontal perspective view of another embodiment of the present invention.

FIG. 5 is a frontal perspective view of a further embodiment of the present invention.

FIG. 6 is a frontal perspective view of a further embodiment of the present invention.

### DETAILED DESCRIPTION OF PREFERRED EMBODIMENTS

Other objects, features and advantages of the invention will become apparent from a consideration of the following detailed description and the accompanying drawings. The following descriptions are made referring to the figures, wherein like reference number refer to like features throughout this description.

One exemplary embodiment of the present invention is shown in FIGS. 1-3. Turning to FIG. 1, a portion control device 10 is shown that can be used to simply and easily manage portions for effective weight loss and maintenance. The portion control device 10 is, in general, comprised of two separate pieces, a rotating platform 12 and a portion container 18.

The portion container 18 is comprised of a circular bottom 28, a circular container wall 26 and a handle 20 extending from the container wall 28, and within the container wall 26 are male threads 16 that spiral downward into the container 18. There are typically 6-12 threads, and in this embodiment, there are a set of eight threads. In any case, there are present at least a pair of threads to accommodate a female thread. In this embodiment, the container wall 26, container bottom 28 and handle 20 are constructed of the same material as a single piece. The portion container 18 is a single-piece construction of a translucent food grade plastic that is suitable for containing food, and is dishwasher safe. One of the advantages of the use of a translucent material to construct the portion container 18 is that it allows the user to see the food, and quantity of food present, as it is added to the container 18.

It is to be understood that the term “food grade plastic” is as commonly understood in the art, and is to include any and all plastics considered to be food grade, including, but not limited to, Polyethylene terephthalate (PET), High-density polyethylene (HDPE), Polyvinyl chloride (PVC), Low-density polyethylene (LDPE), Polypropylene (PP), Polystyrene (PP), and plastics denoted with the “7-Other” designation, such as acrylic, fiberglass, nylon, polycarbonate, or mixes of resins.

The handle 20, depending upon materials of construction, can be hollow, solid or any other configuration able to support the weight of the portion control device 10 and food therein. In this embodiment, the handle 20 has ribs (not shown) within, running along the length of the handle and across the handle to provide additional support.

The rotating platform 12 is circular and has a rounded side portion 12 of sufficient height to accommodate a set of threads 16. In this embodiment, the threads 16 on the side of the rotating platform 12 are female, while the threads 22 within the container 18 are male. There is a typically a set of two to six female threads, and in the embodiment, there are four. In any case, there is at least one female thread to be accommodated by the set of male threads. The rotating platform 12 is further comprised of finger indentations 14a-d for improved ease and speed of rotating the platform 12.

The rotating platform 12 in this embodiment is comprised of a circular platform top 15 and circular side wall 17 to accommodate threads, 16 with the top of the side wall 17 attached to the platform top 15, and no bottom. In this embodiment, and similar to the portion container 18, the rotating platform is a single-piece construction of a translucent food grade plastic that is suitable for contacting food and is dishwasher safe.

To use the portion control device 10, the rotating platform 12 is lowered into the container, as indicated by arrows A and B. As also indicated by arrows A and B in this particular embodiment, the rotating platform 12, which has a circumference less than that of the portion container wall 26 but less than that of the protruding male threads 22 is rotated into the portion container 18, via the respective male threads 22 and female threads 16. A set of finger indentations 14a-d are present at the top of the rotating platform 12, which a user can place a finger or fingers into to spin the rotating platform, thereby making rotation easier.

A measurement indicator is located on the outside of the container 18 showing a series of likely target and maintenance weights or weight ranges, which can be in either pounds or kilograms. In this embodiment, the measurement indicator shows a series of weight ranges from 100-110 lbs. to 200-210 lbs.

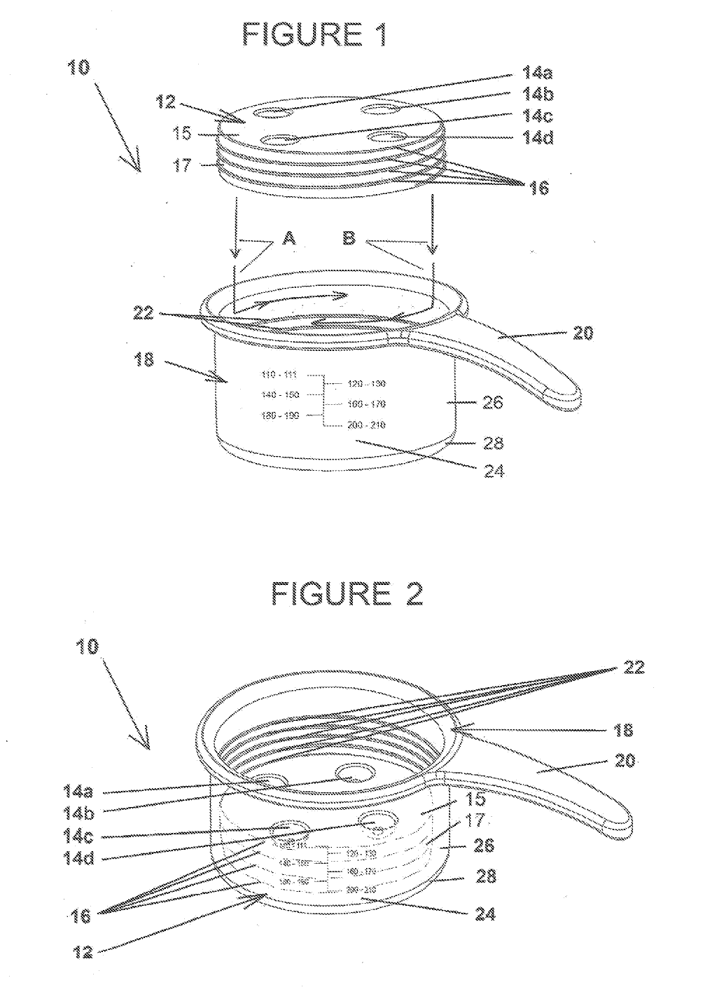

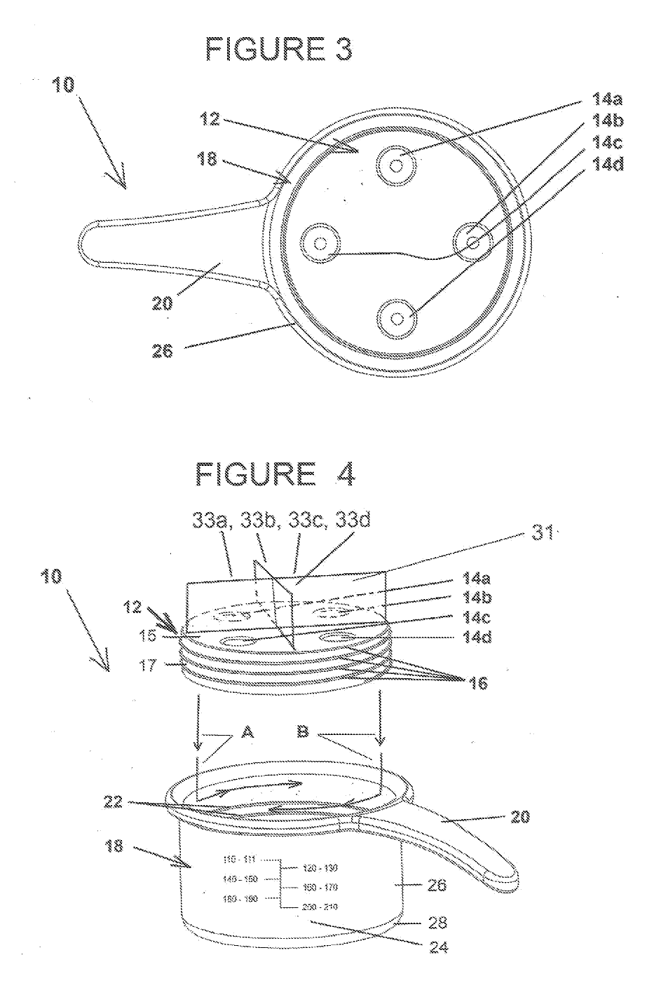

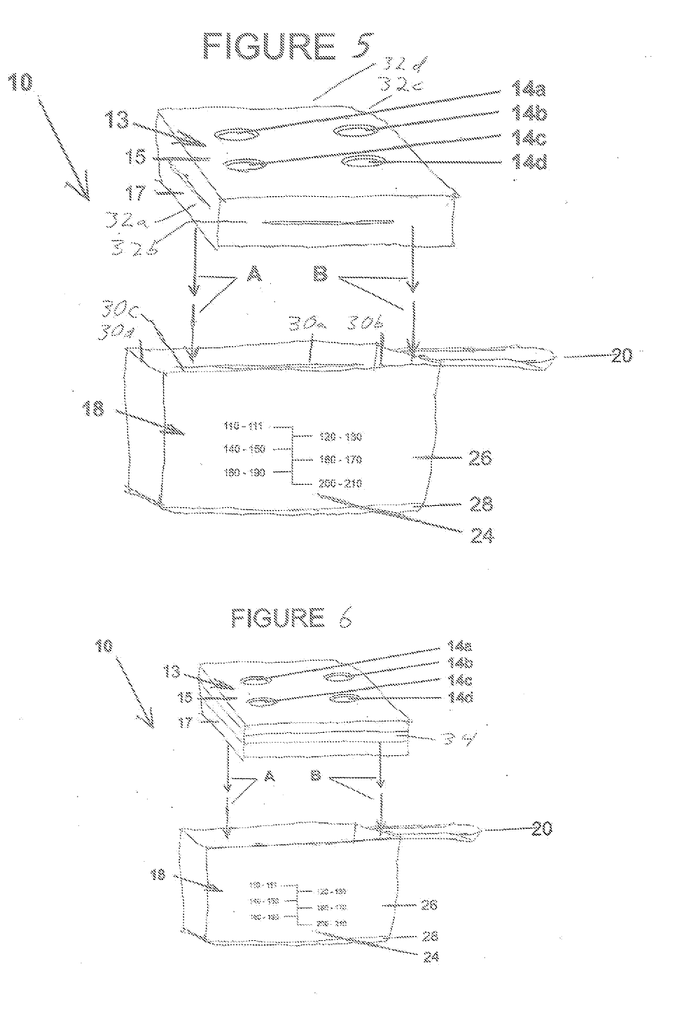

Turning to FIG. 2, the rotating platform 12 is turned until the top 15 is level with the weight range the user is either targeting or maintaining. Turning quickly to FIG. 3, a view of this from the top is shown, with the rotating platform 12 within the container 18, seated by the threads 16, 22.

A properly portioned area has been created above the top 15 of the rotating platform 12 into which the proper amount of food, such as, e.g., a proper portion of meat, vegetables and grain such as wild rice, can be deposited. When the area is full of such food, the proper amount of food for that weight has been reached. The properly portioned meal can then be removed and served.

The lower the maintenance or target weight, the less food that is to be consumed per meal, so the less the rotating platform will be spun down into the portion container 18, and vice versa. For an example, as depicted in FIG. 2, if a particular user's target weight is 100-110 lbs., the user would arm the rotating platform 12 until the top of the platform is level with the line at 100-110 lbs. Since this is the lowest weight range of the series, the rotating platform 12 would be rotated only slightly into the portion container 18. As another example, if a particular user's target weight is 180-190 lbs., the user would turn the rotating platform 12 until the top of the platform is level with the line at 180-190 lbs. Since this is the next to greatest weight range of the series, the rotating platform 12 would be rotated into the portion container 18 nearly to the bottom.

It should also be understood that in further embodiments, the portion container 18 can be constructed, depending upon the particular embodiment, of any suitable material or combination of materials known in the art, such as e.g., non-translucent plastic, glass, metal, a silicone, rubber, wood or other suitable material in the art. It should be understood that this list is representative and not limiting. Further, the respective parts of the container, the container wall 26, container bottom 28 and handle 20, though constructed of the same material in this embodiment as a single piece, can each be made, respectively, of any suitable material and then joined by suitable means known in the art, such as, e.g., by high strength adhesive, screws or rivets.

In further embodiments, any suitable materials and method known in the art which would lower the platform 12 in a controlled manner into the container 18 can be used. For example, the thread types could be reversed, with the rotating platform 12 having male threads and the container 18 having female threads. Further, other means in that art for adjusting the depth of the rotating platform 12 within the portion container 18 can further be employed.

Turning to FIG. 4, in another exemplary embodiment, a divider 31 featuring one or more separation walls 33a, 33b, 33c, 33d is shown attached to the rotating platform 12, so that when the rotating platform 12 is lowered into the portion container 18, the divider 31 acts to separate the interior of the portion container 18, into distinct sections. When the portion container 18 is filled with food, the different kinds of food can be separated by the divider 31. The divider 31 can have any suitable number of separation walls 33a, 33b, 33c, 33d preferably of sufficient number to divide the portion container 18 into between two and four sections. In this embodiment, four sections are provided by the divider 31.

The divider 31 can be attached to the rotating platform 12 by any suitable means in the art. For example, the divider 31 and rotating platform 12 can be a single-piece construction, as depicted in this embodiment. The divider 31 can be a single fixed piece affixed to the rotating platform 12 by means within the art such as adhesive, or a separate detached piece which can be placed on the rotating platform 12 or removed as desired. The divider 31 can also be attached to the rotating platform 12 by means such as slots (not shown) affixed or built into the top of the rotating platform 12. Further, the divider 31 can be constructed of multiple, or movable, walls (not shown), so that the number of areas and size of the areas can be adjusted.

In other embodiments, the rotating platform 12 can be of any suitable construction. For example, it can be a single solid piece, it can be hollow, or other suitable configuration. Further, the rotating platform, like the portion container 18, can be constructed of any suitable material, such as e.g., a non-translucent plastic, glass, metal, a silicone, rubber, wood or other suitable material in the art. It should be understood that this list is representative and not limiting. The respective parts of the rotating platform 12 of this embodiment, the top 15 and wall 17, though constructed of the same material in this embodiment as a single piece, can each be made, respectively, of any suitable material and then joined by suitable means known in the art, such as, e.g., by high strength adhesive, screws or rivets.

Turning to FIG. 5, in an another exemplary embodiment, at least one, and preferable a series of, tongues 30a, 30b, 30c, 30d and grooves 32a, 32b, 32c, 32d can be used for adjustment of a provided platform 13, that may or may not rotate, as appropriate, with the tongues 30a, 30b, 30c, 30d located on the inner wall of the portion control container 18 and the corresponding grooves 32a, 32b, 32c, 32d located on the platform 13, or the other way around. In FIG. 5, 30c, 30d, 32c and 32d are indicated, but hidden from view.

Turning to FIG. 6, in yet another exemplary embodiment, the container 18 and platform 13 can be constructed so as to seal tightly against each other and act as an adjustable plunger type system. This can be done by placing a seal 34 on either the outer portion of the platform 12, the inside wall of the container 18, or both. FIG. 6 depicts an embodiment wherein the seal 34 is located on the outer portion of the platform 12. The seal can be made of any suitable material known in the art, including, but not limited to, rubber, a rubberized material, soft plastic, or a silicone. This sealing can also be accomplished by constructing the platform 12 and container so that the circumference of the outer wall of the platform 12, and inner wall of the container 18 are nearly identical, such that they will fit tightly enough together to provide a temporary seal.

FIGS. 5-6, further illustrate that when a non-thread system is used for securing and adjusting the rotating platform 12 into the container, such as, e.g., the series of tongues 30a, 30b, 30c, 30d and grooves 32a, 32b, 32c, 32d or the plunger type method as herein above, the platform 13 and container 18 can be of any suitable shape, including non-circular shapes such as, e.g., square or rectangular.

By this simple method and device, a user can properly portion a meal easily and within seconds, greatly reducing or eliminating the measuring and memorization otherwise necessary for portioning meals. In addition, this device allows for changes in target weights or weight management goals, as well as being able to accommodate multiple users with different target or maintenance weights.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. An adjustable portion control device comprised of a portion container with a circular interior and a circular rotating platform,
wherein the portion container is further comprised of a measurement indicator located either on the inside or on the outside of the portion container,
and wherein the rotating platform is capable of being seated within the portion control container at adjustable depths indicated by the measurement indicator.

2. An adjustable portion control device according to claim 1, wherein the measurement indicator shows a plurality of weights or weight ranges across a range of target or maintenance weights.

3. An adjustable portion control device according to claim 1, wherein the measurement indicator contains a series of likely target or maintenance weights or weight ranges, and wherein the weights or weight ranges are in either pounds or kilograms.

4. An adjustable portion control device according to claim 1, wherein the range of weight or weights are between about 100 pounds and about 210 pounds.

5. An adjustable portion control device according to claim 1, wherein the portion container is further comprised of a circular bottom, a circular container wall attached to the circular bottom at the bottom of the container wall, and a handle extending from the container wall.

6. An adjustable portion control device according to claim 1, wherein the portion container is further comprised of a circular container wail and wherein the container wall is further comprised of a set of at least two male threads on the inside of the container wall that spiral downward into the container,
and wherein the rotating platform is further comprised of at least one female thread.

7. An adjustable portion control device according to claim 1, wherein the portion container is a single piece.

8. An adjustable portion control device according to claim 7, wherein the portion container and rotating platform are both further comprised of a translucent food grade plastic.

9. An adjustable portion control device according to claim 1, wherein the portion container is comprised of translucent or non-translucent plastic, a plurality of plastics, glass, metal, silicone, rubber, or wood, or any combination of these.

10. An adjustable portion control device according to claim 1, wherein the rotating platform is further comprised of a circular platform top and a circular side wall of sufficient height to accommodate a set of at least one female thread.
and wherein the top of the circular side wall is attached to the circular platform top.

11. An adjustable portion control device according to claim 1, wherein the rotating platform is further comprised of at feast one finger indentation to help improve the ease and speed of rotating the rotating platform.

12. An adjustable portion control device according to claim 1, wherein the rotating platform is comprised of translucent or non-translucent plastic, a plurality of plastics, glass, metal, silicone, rubber, or wood, or any combination of these.

13. An adjustable portion control device according to claim 1, wherein the rotating platform is either a single solid piece or a single hollow piece.

14. An adjustable portion control device according to claim 1, wherein the rotating platform has a sat of at least two male threads and the portion container has at least one female thread.

15. An adjustable portion control device comprised of a portion container with a circular interior, a circular rotating platform, and a divider;
wherein the portion container is further comprised of a measurement indicator located either on the inside or on the outside of the portion container,
and wherein the rotating platform is capable of being seated within the portion control container at adjustable depths indicated by the measurement indicator,
and wherein the measurement indicator shows a plurality of weights or weight ranges across a range of target or maintenance weights,
and wherein the divider is capable of fitting within the portion container and dividing the space within the portion control container into at least two distinct areas.

16. An adjustable portion control device according to claim 15, wherein the divider is comprised of at least one divider wall, and is capable of dividing the space within the portion control container into between two and four distinct areas, and wherein the divider is either a single-piece construction, a multiple piece construction or the rotating platform and divider are a single-piece construction.

17. An adjustable portion control device according to claim 15, wherein the divider is capable of being adjusted to change the size and number of the distinct areas within the portion control container.

18. An adjustable portion control device comprised of a portion container and a platform;
wherein the portion container is further comprised of a measurement indicator located either on the inside or on the outside of the portion container,
and wherein the platform is capable of being seated within the portion control container at adjustable depths indicated by the measurement indicator,
and wherein the measurement indicator shows a plurality of weights or weight ranges across a range of target or maintenance weights,
and wherein the portion container is comprised of a bottom and a container wall attached to the bottom at the bottom of the container wall.

19. An adjustable portion control device according to claim 18, wherein the portion control device is further comprised of at least one tongue and at least one corresponding groove to secure the at least one tongue,
wherein the at least one tongue is located either within the portion control container or on the outside of the platform, and
wherein the at least one groove is located either within the portion control container or on the outside of the platform.

20. An adjustable portion control device according to claim 18, wherein the outer portion of the platform, the inner wall of the portion container, or both are further comprised of a seal.
